(19) United States
(12) Patent Application Publication
(10) Pub. No.: US 2025/0172967 A1
(43) Pub. Date: May 29, 2025

(54) HINGED COMPUTING DEVICES HAVING INTRA-DEVICE WIRELESS COMMUNICATIONS

(71) Applicant: Intel Corporation, Santa Clara, CA (US)

(72) Inventors: Jo-han YU, Hillsboro, OR (US); Chintan THAKKAR, Portland, OR (US); Debabani CHOUDHURY, Thousand Oaks, CA (US); Sidharth DALMIA, Portland, OR (US); Cooper LEVY, Portland, OR (US); Eric GANTNER, Portland, OR (US); Ana YEPES, Portland, OR (US); Huimin CHEN, Beaverton, OR (US); Luis Carlos PANIAGUA ACUNA, San Rafael (CR); Stephen HALL, Middleton, ID (US)

(73) Assignee: Intel Corporation, Santa Clara, CA (US)

(21) Appl. No.: 18/843,042

(22) PCT Filed: Apr. 2, 2022
(86) PCT No.: PCT/US2022/023193

§ 371 Date: Aug. 30, 2024

(51) Int. Cl. G06F 1/16; H01Q 1/22; H01Q 1/24

(52) U.S. Cl. CPC G06F 1/1652; G06F 1/1681; H01Q 1/2266; H01Q 1/24

(57) ABSTRACT

Hinged computing devices having intra-device wireless communications are disclosed. A disclosed example apparatus for use with a foldable computing device includes a hinge by which first and second folding portions of the computing device are rotatably coupled, a first antenna of the first folding portion, a second antenna of the second folding portion, the first and second antennas to be wirelessly communicatively coupled to one another, the first and second antennas separate from the hinge, and equalizer circuitry to enable equalization between the first and second antennas to maintain signals therebetween to meet a bit error rate (BER) threshold over a range of motion of the first folding portion relative to the second folding portion.

### FIELD OF THE DISCLOSURE

This disclosure relates generally to computing devices and, more particularly, to hinged computing devices having intra-device wireless communications.

### BACKGROUND

In recent years, many computing device form factors have shifted to being relatively small and thin. Further, recent improvements in performance have necessitated an increased number of high-speed signals to be routed across hinges of folding/hinged computing devices. These signals can correspond to communication signals, I/O signals, display signals, camera signals, wireless fidelity (Wi-Fi) signals, universal serial bus (USB) signals, etc.

Foldable computing devices with a relatively thin form factor often necessitate high-bandwidth and/or high data rate cables to be routed across a hinge. The hinge cables can typically withstand 40,000 dynamic bend cycles. However, as the computing devices continue to become thinner, the bend radius of the hinge can become even smaller and, thus, the life of the hinge cables can be significantly reduced.

### BRIEF DESCRIPTION OF THE DRAWINGS

FIGS. 1A and 1B illustrate an example folding computing device in accordance with teachings of this disclosure.

FIGS. 2A-2C illustrate example configurations of the folding computing device of FIGS. 1A and 1B.

FIG. 3 illustrates an example wireless communication architecture in accordance with teachings of this disclosure.

FIGS. 4A-4G illustrate example folding ranges enabled by examples disclosed herein.

FIG. 5A-5C illustrate example antenna structures that can be implemented in examples disclosed herein.

FIGS. 6A and 6B illustrate example antenna implementations that can be implemented in examples disclosed herein.

FIGS. 7A and 7B illustrate example characteristics and operational ranges associated with examples disclosed herein.

FIG. 8 is a schematic overview of an example communication architecture that can be implemented in examples disclosed herein.

FIG. 9 illustrates example potential signal robustness across different angular ranges of examples disclosed herein.

FIGS. 10A-10C illustrate example circuit board structures that can be implemented in examples disclosed herein.

FIG. 11 illustrates an example circuit board layering structure that can be implemented in examples disclosed herein.

FIG. 12 is a flowchart representative of an example method to produce examples disclosed herein.

In general, the same reference numbers will be used throughout the drawing(s) and accompanying written description to refer to the same or like parts. The figures are not to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” refer to dimensions that may not be exact due to manufacturing tolerances and/or other real world imperfections. As used herein “substantially real time” refers to occurrence in a near instantaneous manner recognizing there may be real world delays for computing time, transmission, etc. Thus, unless otherwise specified, “substantially real time” refers to real time +/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

### DETAILED DESCRIPTION

Hinged computing devices having intra-device wireless communications are disclosed. In recent years, computing device form factors have shifted to being relatively small and thin. Further, increased performance has necessitated an increased number of high-speed signals being routed across hinges of foldable computing devices. As a result, foldable computing devices with a relatively thin form factor often necessitate relatively high bandwidth and/or data rate cables to be routed through a hinge. The hinge cables can typically withstand 40,000 dynamic bend cycles. However, the cables (and corresponding shielding) can take up a significant volume and can be difficult to route through smaller areas and/or openings.

As the computing devices continue to become even thinner, a bend radius of a hinge can become even smaller and, thus, the life of the hinge cables can be significantly reduced. Reliability can be improved with increased cable thickness and/or stack-up, construction improvements, a dynamic bend radius, and an adjusted bend angle, all of which can impair a reduction in thickness of a computing device. Further, with increasing bandwidth requirements, signal integrity and radio frequency interference (RFI)/electromagnetic interference (EMI) problems can become more significant and, thus, cross-hinge cable designs are implemented to address these issues. However, these cross-hinge cable implementations can be more susceptible to failure. As a result, mechanical reliability and electrical performance requirements can be regarded to be diametrically opposed.

Examples disclosed herein enable highly reliable and cost-effective intra-device wireless interconnections for folding computing devices, such as laptops for example. In particular, examples disclosed herein utilize a relatively short-range wireless connection in a folding computing device to enable first and second folding portions thereof to wirelessly communicate. In particular, the first and second folding portions are rotatably coupled about a hinge. According to examples disclosed herein, a first wireless antenna is positioned on the first folding portion while a second wireless antenna is positioned on the second folding portion. In particular, the aforementioned first wireless antenna and the second wireless antenna wirelessly communicate with one another across the hinge with a relatively high bandwidth therebetween. To that end, examples disclosed herein utilize equalizer communication circuitry to enable equalization between the first and second antennas to maintain signals therebetween meeting a quality of service threshold (QoS) over a range of motion of the first folding portion relative to the second folding portion, thereby enabling relatively high bandwidth communications to be maintained between the first and second folding portions. As a result, examples disclosed herein can enable high bandwidth intra-device wireless signals, such as, but not limited to, those necessitated to support video transmission including video signals, across a wide angular range of motion (e.g., rotational angles) between the first and second folding portions. Further, examples disclosed herein do not necessitate compact wiring and/or structures that can prematurely fail and, thus, examples disclosed herein can enable highly robust and reliable hinge structures/assemblies while enabling communications with relatively high data rates. As a result, examples disclosed herein can enable compact and thinner form factors for folding computable devices. Some examples disclosed herein can utilize wireless transmitter/receiver pairs and/or transceivers to be implemented with the first and second antennas, for example.

In some examples, the hinge does not include any signal (e.g., high bandwidth signal) wiring or cabling (e.g., the hinge does not include any wiring or cabling). In some examples, the hinge includes a cylindrical barrel. In some such examples, the first and second wireless antennas are positioned outside of and/or away from an outer circumference and/or outer surface of a barrel of the hinge and, thus, do not extend into an inner portion (e.g., an inner radius) of the barrel. Additionally or alternatively, at least one of the first and second antennas is mounted on or within a circuit board (e.g., a printed circuit board, a flexible circuit board, etc.). In some such examples, at least one of the first antenna or the second antenna is printed onto a respective circuit board.

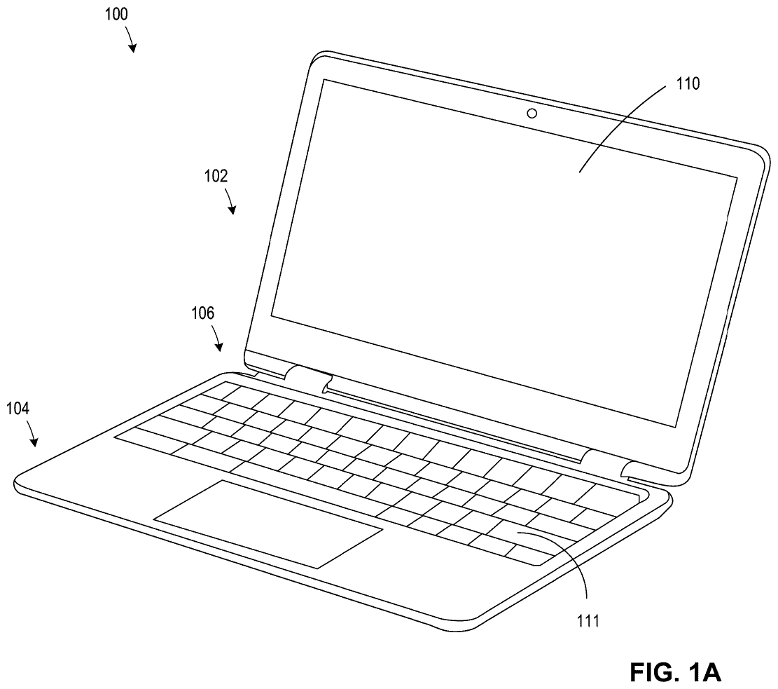

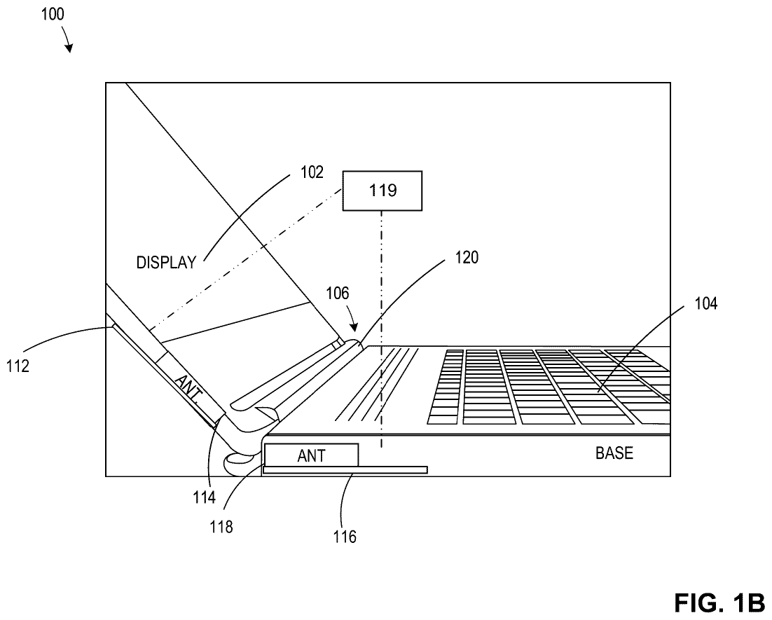

FIG. 1A is an example folding computing device 100 in accordance with teachings of this disclosure. In the illustrated example of FIG. 1A, the computing device 100 includes a first folding portion (e.g., a display, a display portion, a chassis, frame, etc.) 102 and a second folding portion (e.g., a base, a keyboard, a keyboard portion, an input portion, a chassis, frame, a motherboard, a second display portion, etc.) 104. In this example, the first folding portion 102 is rotatably coupled to the second folding portion 104 about a hinge 106. The example first folding potion 102 supports and positions a display 110 while the second folding portion 104 supports an input device 111, which is implemented as a keyboard in this example. However, the input device 111 can be any other appropriate type of input device including a button array, a trackball, a mouse, etc. Additionally or alternatively, the second folding portion 104 supports an additional display or a display portion that is integral and/or unitary with the display 110 (e.g., a foldable display).

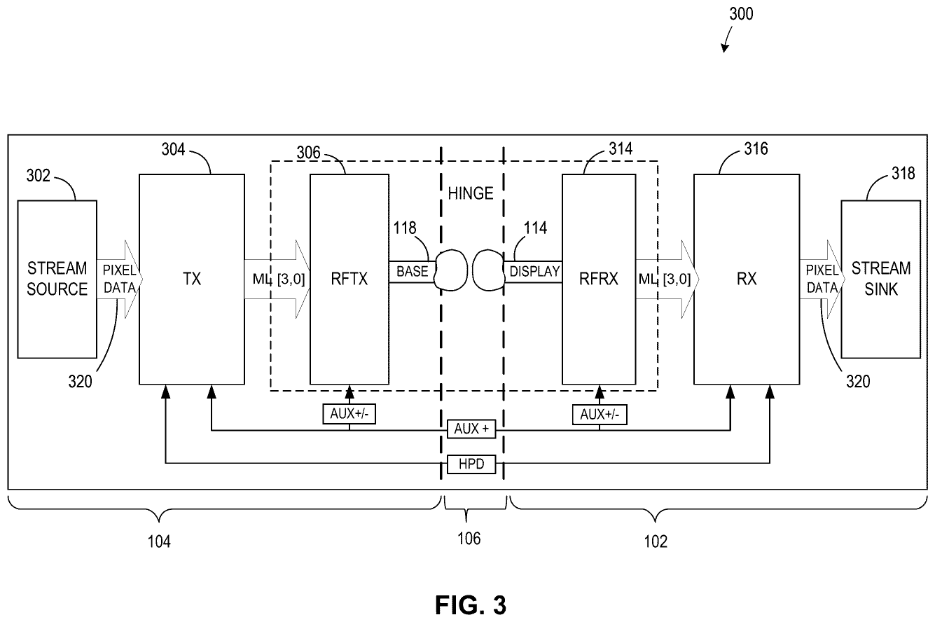

Known folding computing devices typically necessitate numerous wires and/or connectors that traverse a hinge between folding portions. In contrast, examples disclosed herein do not necessitate a significant volume and/or quantity of connectors/wires to extend across a hinge. As will be discussed in greater detail below in connection with FIGS. 3-12, examples disclosed utilize a wireless communication between the first folding portion 102 and the second folding portion 104, thereby enabling the hinge 106 to be relatively compact by reducing an amount of cabling or other hardware that has to traverse the hinge 106. Examples disclosed herein can also increase a reliability of the hinge 106 and/or associated components of the hinge 106.

While the folding computing device 100 is implemented as a laptop computer in this example, the folding computing device 100 can be implemented as any other appropriate device including, but not limited to, a tablet, a mobile phone, a folding tablet or phone, a folding gaming controller, etc. For example, the computing device 100 can be implemented as a folding mobile device (e.g., a phone, a tablet) with another display on the second folding portion 104. In some such examples, the display 110 and the additional display can be unitary (e.g., the unitary display folds about the hinge 106).

Turning to FIG. 1B, a partial cutaway side view of the example computing device 100 is shown. As can be seen in the illustrated example of FIG. 1B, the first folding portion 102 includes and/or supports a circuit board (e.g., a motherboard) 112 which, in turn, supports and positions a first antenna (e.g., a first antenna array) 114. Likewise, the second folding portion 104 includes and/or supports a circuit board (e.g., a motherboard) 116 which, in turn, supports and positions a second antenna (e.g., a second antenna array) 118. In this example, the first antenna 114 and the second antenna 118 are operated with radio frequency integrated circuit (RFIC) implementations. However, any other appropriate antenna structure, technology, communication architecture and/or coupling can be implemented instead. In the illustrated example, communication circuitry (e.g., equalization communication circuitry, RFIC) 119 is implemented on (e.g., attached to, coupled to, etc.) the circuit board 112 and/or the circuit board 116. Further, while the first antenna 114 and the second antenna 118 are shown on a side of the computing device 100, the antenna 114 and the antenna 118 can be positioned along any lateral position (e.g., a lateral distance from a side of the computing device 100) and/or spanwise position (e.g., a center spanwise position, etc.) of the computing device 100 and/or the hinge 106.

To enable wireless communications between the first antenna 114 and the second antenna 118 to have a sufficient data bandwidth and/or meet a threshold quality of service (QoS) and/or bit error rate (BER) over a range of angular displacement (e.g., a full range of angular displacement) between the first folding portion 102 and the second folding portion 104, the first antenna 114 and the second antenna 118 are communicatively coupled to one another with an equalization architecture defined by the communication circuitry 119. In this example, the antenna 114 is positioned on the circuit board 112 (e.g., printed onto the circuit board 112, fabricated onto the circuit board 112, mounted to the circuit board 112, tethered from the circuit board 112, etc.) at or proximate a proximal end of the first folding portion 102 that is relatively close to the hinge 106. In some examples, the antenna 114 is printed onto an RFIC package that is mounted onto the circuit board 112. Likewise, the antenna 118 supported by the circuit board 116 (e.g., printed onto the circuit board 116, fabricated onto the circuit board 116, mounted to the circuit board 116, tethered from the circuit board 116, etc.) is positioned at a proximal end of the second folding portion 104 that is relatively close to the hinge 106. In some examples, at least one of the first antenna 114 or the second antenna 118 is oriented toward the hinge 106. Additionally or alternatively, at least one of the first antenna 114 or the second antenna 118 is oriented to radiate generally toward the hinge 106. In this example, the first antenna 114 and the second antenna 118 are communicatively coupled via a millimeter wave (mmWave) communication protocol controlled by the example communication circuitry 119. However, any other appropriate communication protocol and/or architecture can be implemented instead. In some examples, the first antenna 114 or the second antenna 118 is mounted to and/or in communication with a mainboard (e.g., a motherboard, a main display board, etc.) of the corresponding first folding portion 102 or the second folding portion 104.

In this example, the hinge 106 includes a barrel 120, which has a generally cylindrical cross-sectional profile (in the view of FIG. 1B). However, the example barrel 120 and/or a cross-sectional profile thereof can be any appropriate shape (e.g., rectangular, oblong, oval, triangular, etc.). According to the illustrated example, the first antenna 114 and the second antenna 118 are positioned away from (e.g., external to) an outer surface (e.g., an outer diameter) of the hinge 106. Additionally or alternatively, the first antenna 114 and the second antenna 118 are positioned along an edge of the hinge 106. As a result, signal cabling that passes through the hinge 106 can be reduced (e.g., eliminated). In some examples, only power cabling is routed through the hinge 106. In this example, the first antenna 114 and the second antenna 118 are separated by a distance of approximately 5 millimeters (mm) to 10 mm. However, any other appropriate distance can be implemented instead.

While the first antenna 114 and the second antenna 118 are board mounted in this example, in some examples, the first antenna 114 and/or the second antenna 118 can extend away from a respective circuit board (e.g., via a ribbon cable or other extension). In some examples, the first folding portion 102 includes an additional third antenna. In some such examples, the first antenna 114 is an end-firing antenna and the third antenna is a broadside antenna. Additionally or alternatively, the second folding portion 104 includes an additional fourth antenna. In some such examples, the second antenna 118 is an end-firing antenna and the fourth antenna is a broadside antenna. In other words, at least one of the first folding portion 102 or the second folding portion 104 can include a combination of broadside and end-firing antennas.

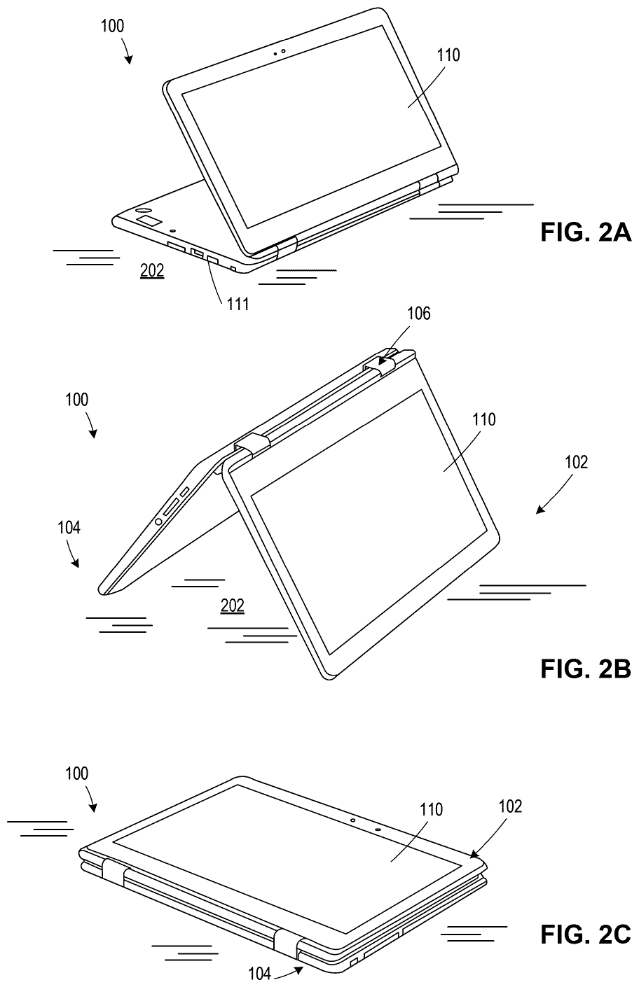

FIGS. 2A-2C illustrate example folding configurations of the example folding computing device 100 of FIGS. 1A and 1B. In particular, the example folding configurations are different from the laptop configuration shown in FIGS. 1A and 1B. Turning to FIG. 2A, the computing device 100 of the illustrated example is shown in a configuration in which the display 110 is shown angled from the input device 111, which is placed facing down toward a table surface 202. As a result, the example computing device 100 is operated as a display stand.

FIG. 2B depicts the example computing device 100 in a standing tent-like configuration. In the illustrated example, the first folding portion 102 and the second folding portion 104 support the hinge 106 in an upward position from the table surface 202. Further, the display 110 is angled from the table surface 202. A viewing angle of the display 110 can be adjusted by varying an angle of the hinge 106.

Turning to FIG. 2C, the example computing device 100 is shown in a tablet configuration such that the first folding portion 102 is folded to contact the second folding portion 104 such that the display 110 faces in a direction directly away from the table surface 202. In this example, the computing device 100 is folded to a generally flat configuration.

Examples disclosed herein can maintain wireless communications between the folding portion 102 and the second folding portion 104 in the configurations shown in FIGS. 1A-2C. In particular, examples disclosed herein enable relatively high bandwidth communication rates between the first folding portion 102 and the second folding portion 104 along a wide range of motion (e.g., an entire range of motion) therebetween.

FIG. 3 illustrates an example wireless communication architecture 300 in accordance with teachings of this disclosure. The example wireless communication architecture 300 can be implemented in conjunction with the communication circuitry 119 shown in FIG. 1B for wireless video or high speed I/O (HSIO) communications across the hinge 106. In particular, the wireless communication architecture 300 includes a source (e.g., a high speed data source, a video source, a source encoder, a video signal processor, a graphics processing unit, etc.) 302, a transmitter circuit (e.g., a wired transmitter circuit) 304, a radio frequency (RF) transmitter (e.g., an RF transceiver) 306, the second antenna 118, the first antenna 114, an RF receiver (e.g., an RF transceiver) 314, a wired receiver, a receiver circuit (e.g., receiver processor circuitry) 316 and a sink (e.g., a stream sink) 318.

In operation, the example source 302 provides a signal 320 to the sink 318. In particular, the signal 320 corresponds to video signals (e.g., DisplayPort video signals, display signals, etc.) for the display 110 shown in FIGS. 1A and 1B. In particular, the signal 320 is provided from the source 302 to the sink 318 to drive the display 110.

To transmit information corresponding to the signal 320 across the hinge 106, the wireless transmitter 306 and the wireless receiver 314 are implemented. In some other examples, both the first antenna 114 and the second antenna 118 are communicatively and/or electrically coupled to respective transceivers (e.g., transmitter/receiver pairs, etc.). In this example, at least one of the transmitter 306 or the receiver 314 includes and/or is communicatively coupled to communication circuitry that supports equalization. In this example, the transmitter 306 and the receiver 314 are external to the hinge 106. In particular, the transmitter 306 and the receiver 314 are not internal to the hinge 106 and are at or away from an external surface (e.g., an external diameter) of the hinge 106. In some such examples, the hinge 106 can exhibit a generally cylindrical shape and/or include a generally cylindrically shaped barrel.

In some examples, some wiring and/or cabling does extend through and/or across the hinge 106 (e.g., cables supporting power and low speed signals still traverse the hinge 106). In other examples, no wiring and/or cabling extends through the hinge 106. In some such examples, the first folding portion 102 includes a first power source (e.g., a first battery, a first cable, etc.) and the second folding portion 104 includes a second power source (e.g., a second battery, a second power cable, etc.) different and/or independent from the first power source. Additionally, the first folding portion 102 and the second folding portion 104 can be environmentally sealed (e.g., hermetically sealed), for example. In some examples, an array and/or combination of antennas (e.g., an array of broadside antennas, an array of end-firing antennas) is implemented in at least one of the first folding portion 102 or the second folding portion 104. In some such examples, beam steering is utilized between the first folding portion 102 and the second folding portion 104. In some particular examples with combination antennas, a broadside antenna or end firing antenna thereof can be selected based on an angle between the first folding portion 102 and the second folding portion 104. Additionally or alternatively, a first strength of the broadside antenna and a second strength of the end-firing antenna can be selected based on the angle between the first folding portion 102 and the second folding portion 104.

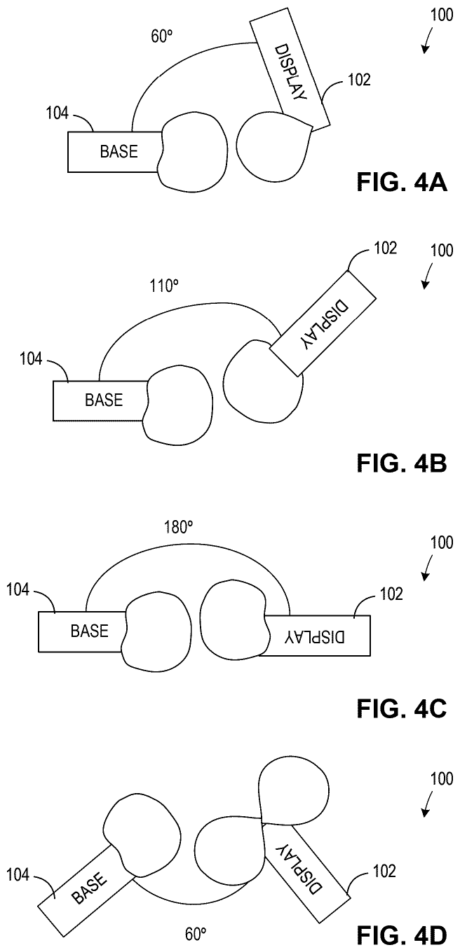

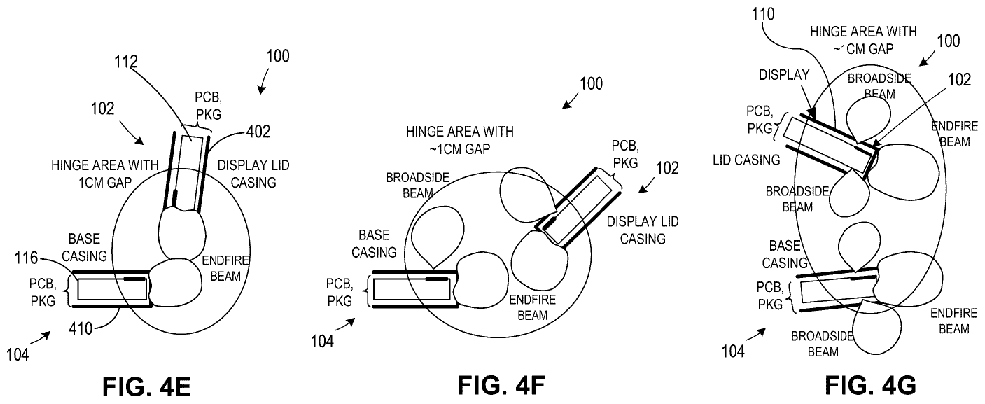

FIGS. 4A-4G illustrate example folding configurations enabled by examples disclosed herein. In particular, FIGS. 4A-4G are simplified side-view representations of the computing device 100. Turning to FIG. 4A, the example first folding portion 102 is shown at an angle of 60 degrees (°) from the second folding portion 104. In this example view, the second folding 104 portion utilizes an end-firing antenna while the first folding portion 102 utilizes a broadside antenna. In some examples, the first folding portion 102 and/or the second folding portion 104 can switch between an end-firing antenna implementation or a broadside antenna implementation based on measured signal strengths, detected orientation(s), bandwidth measurements, etc. (e.g., via the communication circuitry 119). Additionally or alternatively, the first folding portion 102 and/or the second folding portion 104 simultaneously and/or selectively operate a combination of an end-firing antenna and a broadside antenna.

FIG. 4B depicts the example first folding portion 102 shown at an angle of 110° from the second folding portion 104. In the illustrated example, both the first folding portion 102 and the second folding portion 104 operate with end-firing antenna beams.

Turning to FIG. 4C, the example first folding portion 102 is shown at an angle of 180° from the second folding portion 104. Similar to the example of FIG. 4B, both the first folding portion 102 and the second folding portion 104 operate with end-firing antenna beams.

FIG. 4D depicts the example first folding portion 102 at an angle of 60° from the second folding portion 104, which is distinct from the angle shown in the example of FIG. 2B. In the illustrated example, the first folding portion 102 operates utilizing broadside antenna beams and the second folding portion 104 operates utilizing end-firing antenna beams.

FIG. 4E is a detailed partial cross-sectional view of a hinge area of the computing device 100. In this example, the first folding portion 102 includes a housing (e.g., a frame a chassis, etc.) 402 that at least partially encloses and/or surrounds the circuit board (e.g., a printed circuit board, a flexible circuit, a transceiver board, etc.) 112. In turn, the circuit board 112 positions and/or supports at least one antenna (e.g., the antenna 114) at or proximate a distal end (e.g., a hinge end) thereof. Similarly, the second folding portion 104 includes a housing (e.g., a frame a chassis, etc.) 410 that at least partially encloses and/or surrounds the circuit board (e.g., a printed circuit board, a flexible circuit, a transceiver board, etc.) 116. Further, the circuit board 116 positions and/or supports at least one antenna (e.g., the antenna 118) at or proximate a distal end (e.g., a hinge end) thereof.

In this example, the first folding portion 102 is separated from the second folding portion 104 by approximately 1 centimeter (cm). However, any appropriate distance may be implemented instead. In some examples, the circuit board 112 and/or the circuit board 116 are implemented with a system on a chip (SOC) package associated with transmitting and/or receiving signals between the first folding portion 102 and the second folding portion 104. In this example, the antenna(s) of the first folding portion 102 and the antenna(s) of the second folding portion 104 are communicatively coupled via end-fire beams emitted and/or radiated therefrom. However, any other appropriate omni and directional antenna systems can be implemented instead.

FIG. 4F is another detailed partial cross-sectional view of the hinge area of the computing device 100, but with a different angular displacement of the first folding portion 102 relative to the second folding portion 104 to that shown in FIG. 4E. In the illustrated example of FIG. 4F, the antenna(s) of the first folding portion 102 and the antenna(s) of the second folding potion 104 are communicatively coupled via end-fire and broadside beams.

FIG. 4G is yet another detailed partial cross-sectional view of the hinge area of the computing device 100. In the illustrated example of FIG. 4G, the antenna(s) of the first folding portion 102 and the antenna(s) of the second folding portion 104 are communicatively coupled via end-fire and broadside beams. In this particular, example, both the antenna(s) of the first folding portion 102 and the antenna(s) of the second folding portion 104 utilize and/or emit multiple opposing broadside beams. For example, the antenna(s) of the first folding portion 102 emits a first one of the opposing broadside beams from a first side pertaining to the display 110 and a second one of the opposing broadside beams from a second side that is opposite to the first side. Likewise, the antenna(s) of the folding portion 104 emits opposing broad side beams from the opposing sides thereof. In some examples, the end-fire beams corresponding to both the first folding portion 102 and the second folding portion 104 are not utilized for communication therebetween.

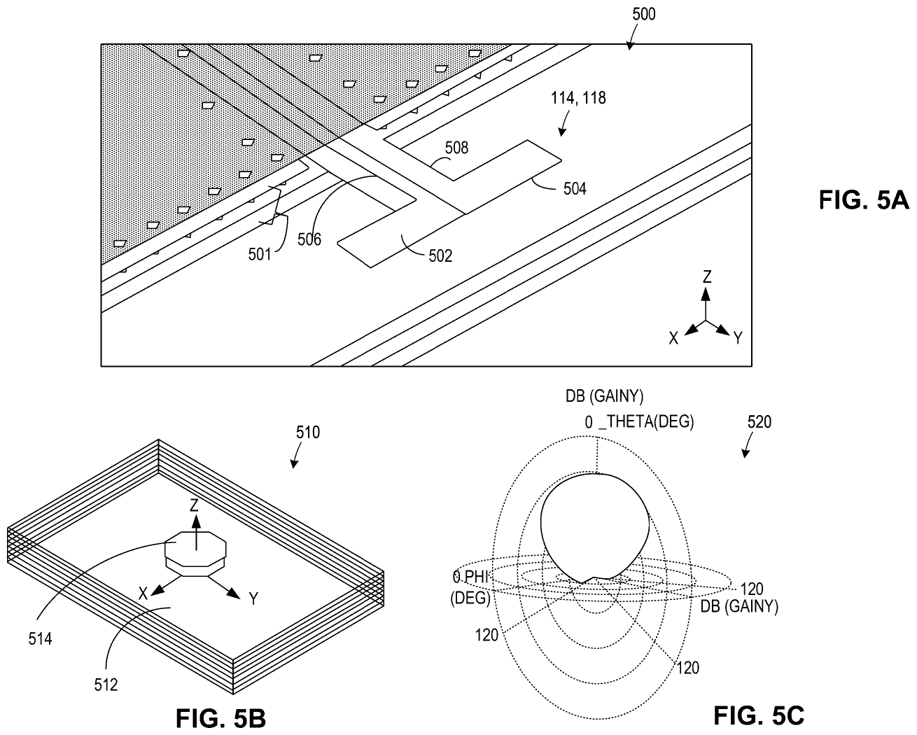

FIG. 5A illustrates an example antenna structure 500 that can be implemented in examples disclosed herein. The example antenna structure 500 is end-firing and can be implemented in the antenna 114 and/or the antenna 118. In this example, the antenna structure 500 extends from a circuit board 501 and is implemented as a dipole antenna for end-fire beam emissions. To that end, the example antenna structure 500 and/or an end the circuit board 501 may be placed near a hinge area, for example (e.g., a distal end of the folding portion 102 proximate the hinge area, a distal end folding portion 104 proximate the hinge area).

In the illustrated example of FIG. 5A, the antenna structure 500 includes a first branch 502 and a second branch 504, both of which extended from an arm 506 and an arm 508, respectively. In this example, the antenna structure 500 is printed onto the circuit board 501. Additionally or alternatively, the example antenna structure 500 extends away from the circuit board 501 and toward the hinge 106. In this example, the antenna structure 500 is fully enclosed within a corresponding folding portion (e.g., the first folding portion 102 or the second folding portion 104) and/or computing device enclosure (e.g., housing, base, display, etc.). However, in some other examples, at least a portion of the antenna structure 500 extends out of an opening (e.g., an opening in a housing) of a corresponding folding portion (e.g., the first folding portion 102, the second folding portion 104, etc.).

FIG. 5B depicts an example broadside antenna 510, which can be implemented in the first antenna 114 and/or the second antenna 118. In the illustrated example, the antenna 510 includes antenna arrays (e.g., layered planes) 512 with a corresponding emissive section or portion 514.

FIG. 5C depicts an example radiative pattern 520 that corresponds to the example broadside antenna 510 shown in FIG. 5B.

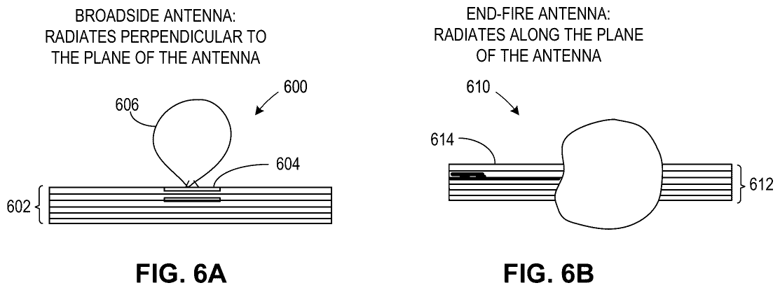

FIGS. 6A and 6B illustrate example antenna implementations 600, 610, respectively, that can be implemented in examples disclosed herein. Turning to FIG. 6A, the example broadside antenna implementation 600 is shown. In this example, a circuit board 602 includes an antenna 604 positioned thereon with a corresponding radiative emission 606 depicted. In this example, the antenna 604 is printed and/or fabricated onto a top or bottom surface of the circuit board 602 (in the view of FIG. 6A) so that the antenna 604 can transmit and/or receive in a relatively perpendicular direction to a plane of the antenna 604 and/or the circuit board 602. In some examples, the antenna 604 is assembled or placed onto the circuit board 602.

Turning to FIG. 6B, an example end-firing antenna implementation 610 is shown. In this example, a circuit board 612 supports and positions an antenna 614, which transmits along a generally lateral length or distance of the circuit board 612. In other words, the antenna 614 of the illustrated example radiates along a plane of the antenna 614.

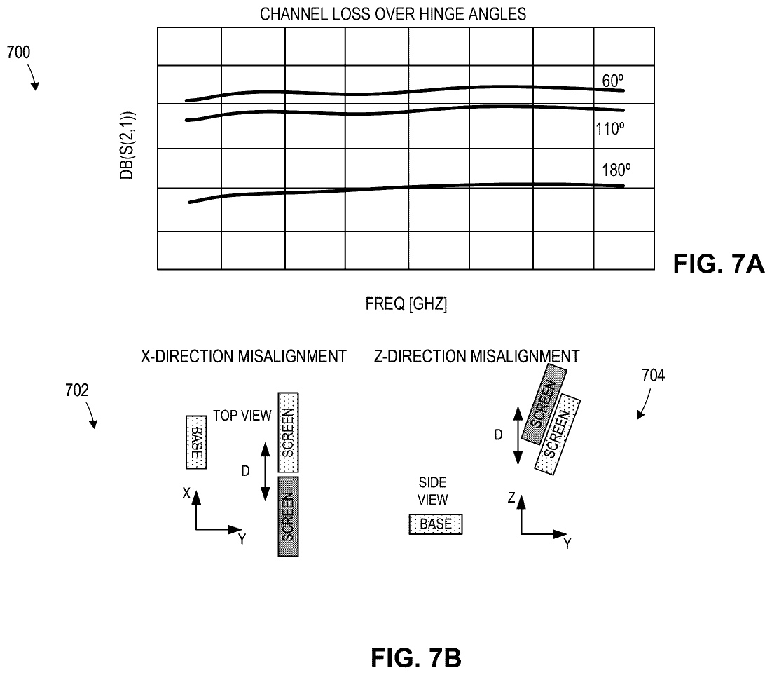

FIGS. 7A and 7B illustrate example characteristics and operational ranges associated with examples disclosed herein. Turning to FIG. 7A, an example graph 700 depicts channel and/or radio frequency (RF) loss with respect to different angles of rotation of the of the first folding portion 102 with respect to the second folding portion 104. In this example, angles of 60°, 110° and 180° of the first folding portion 102 to the second folding portion 104 are shown. Further, the example of FIG. 7A corresponds to a combination of broadside and end-firing antennas of each of the first folding portion 102 and the second folding portion 104. As can be seen in the example of FIG. 7A, examples disclosed herein, channel loss is relatively consistent across different frequencies at different hinge angles.

FIG. 7B includes a depiction 702 showing an x-direction misalignment and a depiction 704 showing a z-direction misalignment. In the illustrated example of FIG. 7B, the first folding portion 102 and the second folding portion 104 both include an end-firing antenna. In turn, an example chart 710 illustrates signal losses associated with the x-direction misalignment and the z-direction misalignment. Accordingly, examples disclosed herein are not sensitive to physical and/or mechanical misalignment. Accordingly, examples disclosed herein can have a relatively large degree of flexibility in placement in contrast to known systems, which typically necessitate antennas being accurately aligned together, which is distinct from known systems.

The example of FIG. 7B corresponds to a misalignment of approximately 5 mm in both x and z directions between the second antenna 118 on the second folding portion 104 and the first antenna 114 on the first folding portion 102 shown in FIG. 1B.

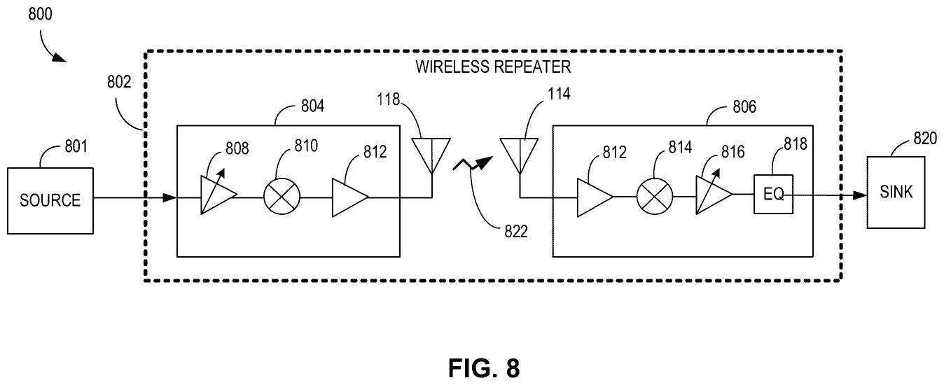

FIG. 8 is a schematic overview of an example communication architecture 800 that can be implemented in examples disclosed herein. The example communication architecture 800 is a block diagram for an implementation of a wireless repeater that utilizes equalization. The example communication architecture 800 can be implemented to prevent signal degradation and/or enhance signal accuracy between the first folding portion 102 and the second folding portion 104. In the illustrated example of FIG. 8, the communication architecture 800 includes a source 801, which transmits a video signal in this example, and a block 802 that represents a wireless repeater. In turn, the block 802 includes transmitter circuitry 804 and receiver circuitry 806. The example transmitter circuitry 804 includes a variable amplifier 808, a transmitter 810 and an amplifier 812, all of which correspond to the second antenna 118. Further, the example receiver circuitry 806 includes an amplifier 812, a receiver 814, a variable amplifier 816, and equalizer circuitry 818. The receiver circuitry 806 of the illustrated example corresponds to the first antenna 114 of the first folding portion 102. In turn, the example communication architecture 800 also includes a sink 820 to receive the aforementioned video signal from the source 801, for example. The example communication architecture 800 is only an example and any appropriate architecture can be implemented instead. In the illustrated example of FIG. 8, a signal 822 represents a wideband mmWave or sub-terahertz wireless signal. However, any other appropriate signal type and/or frequency can be implemented instead.

In the illustrated example, a wireless repeater implementation is shown. However, other methods of wirelessly transmitting source information to the sink 820 at mm Wave or sub-terahertz frequencies can be implemented instead. In this example, the transmitter circuitry 804 utilizes variable-gain amplification (VGA), frequency up-conversion, and radio frequency amplification. The example receiver circuitry 806 implements radio frequency amplification, frequency down-conversion, and VGA. The example equalizer circuitry 818 utilizes equalization in the receiver circuitry 806, but, additionally or alternatively, can be implemented at other nodes or in receiver or transmitter signal chains, thereby improving performance of the wireless link.

In some examples, equalization between the first antenna 114 and the second antenna 118 is adjusted based on an angle (e.g., an angle measured by a sensor) between the first folding portion 102 and the second folding portion 104. In some such examples, parameters such as equalization coefficients can be adjusted to maintain a BER threshold (e.g., to maintain a BER level below a BER threshold).

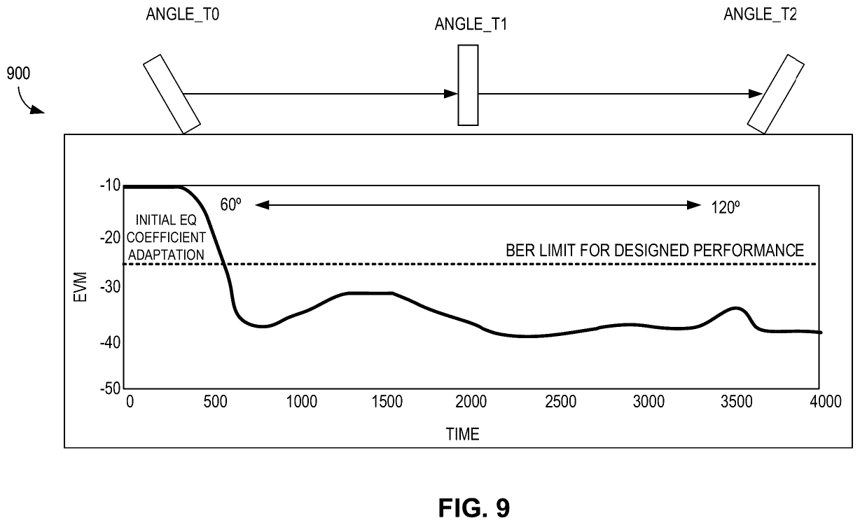

FIG. 9 illustrates example potential signal robustness across different angular ranges of examples disclosed herein. In the illustrated example of FIG. 9, a link adaptation simulation result for a moving and/or displacing hinge is shown. In some examples, subsequent to an initial equalizer convergence, the coefficients can adapt sufficiently quickly such that a hinge can move 60-degrees in less than a time period significantly faster than human movement timescales and EVM sufficient with a BER limit and/or threshold is maintained, for example.

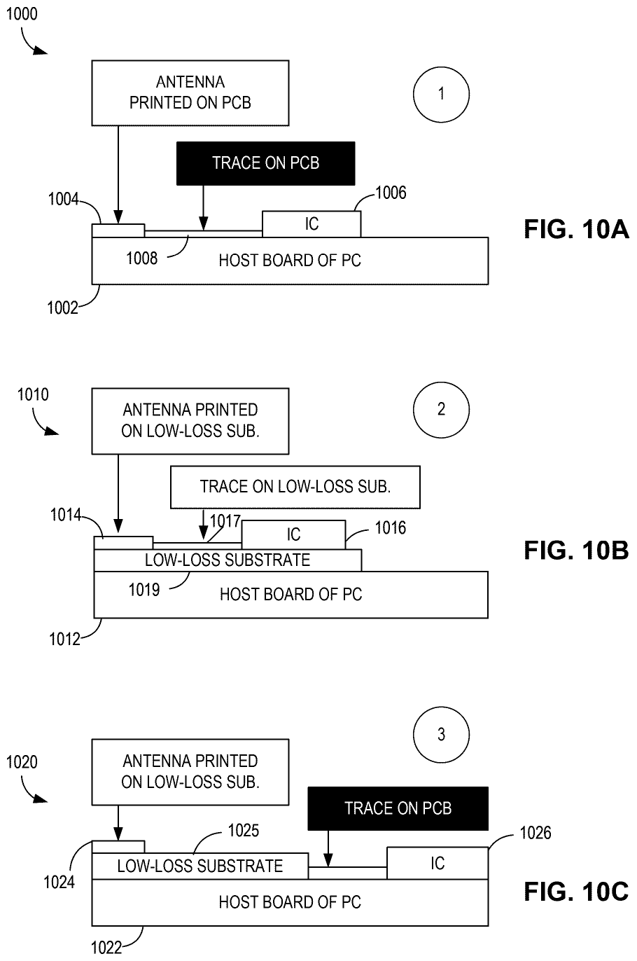

FIGS. 10A-10C illustrate circuit board structures that can be implemented in examples disclosed herein. Another important aspect of examples disclosed herein utilizing an mmWave link is packaging and placement on a board of both an antenna and an integrated circuit for the transceiver. There are multiple example configurations such as those examples shown in FIGS. 10A-10C. While an IC is typically placed on a package with low-loss material that is mounted on a host board, the IC can also be directly attached to a host board. Some example implementations include (1) printing an antenna on a host board, (2) printing an antenna on an RFIC package and (3) printing an antenna on a low loss material for attachment as a surface mount component (examples (1)-(3) are shown in FIGS. 10A-10C, respectively).

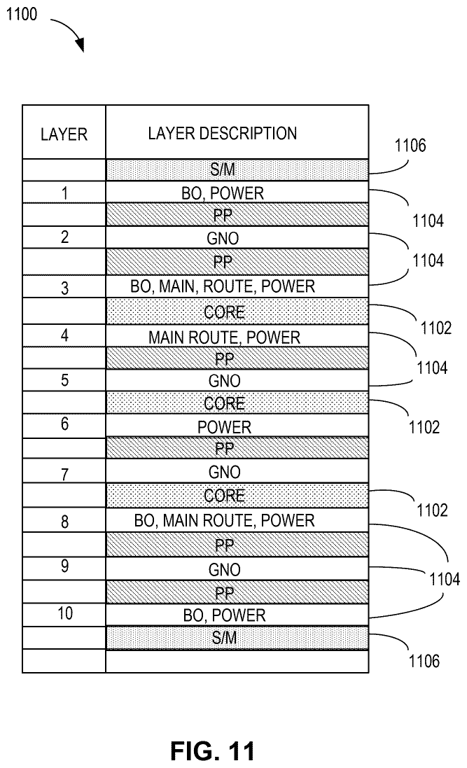

Turning to FIG. 10A, an example implementation 1000 in which an antenna is printed and mounted on a PCB with an RFIC is shown. In the illustrated example, a host board 1002 supports an antenna 1004. In this example, the antenna 1004 is electrically coupled/connected to an IC 1006 via traces 1008 on the board 1002. In some examples, printing the antenna 1004 onto the FR-4 board can correspond to reduced costs. In some examples, a higher dielectric constant and a higher loss tangent can degrade antenna gain, as well as the operation bandwidth. Improving the alignment of radiation patterns from antennas on opposite sides of the hinge 106 can help to compensate the higher material loss. Some simulations indicate that even if antennas have gain degradation, with an improved (e.g., optimized) link distance and pattern alignment, the channel loss can meet the link budget. On the other hand, near future PCB technology indicates trends of including lower-loss materials as part of the host board while maintaining lower costs by using hybrid PCBs (shown in FIG. 11). Another example implementation includes adding air gaps between layers, thereby further lowering the dielectric loss and permittivity. In some examples, these air gaps/cavities can be implemented by drilling relatively small/un-plated holes in a board proximate an antenna.

FIG. 10B depicts an example implementation 1010 in which an antenna is printed and integrated with an RFIC on a low-loss material (e.g., as a single package that can be mounted on PCB material). In this example, a printed antenna 1014 is positioned on an RFIC package that is mounted to a host board 1012. In particular, the printed antenna 1014 is electrically coupled/connected to an IC 1016 via a trace 1017. In this example, the antenna 1014 is printed on a low-loss substrate 1019 which, in turn, is supported by a host board 1012. According to examples disclosed herein, printing the antenna 1014 on a relatively low-loss RFIC package can have a higher cost, but can result in numerous benefits. According to examples disclosed herein, RF performance can be improved due to interconnections between the antenna 1014 and the IC 1016 being on the low-loss substrate 1019, as well as shortening these connections in addition to removing additional vias and parasitics. Further, partially shielding the package and exposing the mmWave antenna can improve RFI mitigation and RF immunity. In particular, examples disclosed herein can improve antenna isolation from platform noise and/or reflections from other system components and/or external devices/components. According to examples disclosed herein, the aforementioned RFIC package can be easily mounted onto the host board 1012 at a desired location (e.g., an edge of the board 1012) and at various angles. Benefiting from the compact size of mmWave antennas, the entire package should be significantly smaller than the existing cable connectors typically used in known platforms (occupying less volume).

In the example implementation 1020 of FIG. 10C, an antenna is printed on a low-loss material as a single package that can be mounted to PCB material, such that an RFIC is also mounted to the PCB material. In particular, printing an example antenna 1024 on a low loss substrate material 1025 for attachment as a surface mount component onto a host board 1022 is shown. In contrast to integrating the antenna 1024 with an RFIC 1026 on the same low-loss substrate 1025, separating the antenna 1024 and RFIC 1026 onto two packages can provide increased flexibility for antenna and IC device selection. Printing the antenna on a well-defined package substrate (as opposed to printing on the host board 1022) improves uniformity across platforms and can relieve customers (ODMs) of the burden of antenna implementation. In examples where the mmWave antenna 1024 and the low-loss substrate 1025 are formed as a surface mount component, additional use in other applications can be realized. For the examples shown FIGS. 10B and 10C, the surface-mounted component with low-loss substrate can be coupled/connected to the board by partially hanging off an edge of the board. Such an example approach can facilitate (e.g., optimize) antenna placement and alignment between transmit and receive antennas for an improved link performance across different hinge angles.

FIG. 11 illustrates an example circuit board layering structure 1100 that can be implemented in examples disclosed herein. In this example, the circuit board layering structure 1100 corresponds to a hybrid stack-up FR-4 board with a relatively low loss (e.g., a relatively low loss material and/or layer). In this example, layers 1102 correspond to low-loss layers, layers 1104 correspond to metal layers, and layers 1106 correspond to solder mask layers. The board layering structure 1100 can be produced by printing at least some portions thereof. The example hybrid stack-up approach of examples disclosed herein enables for reduced costs based on having one or a few low-loss layers as opposed to an entire layer stack-up, thereby enabling examples disclosed herein to be easily implemented on common PCB stack-ups. However, any appropriate layering structure can be implemented instead.

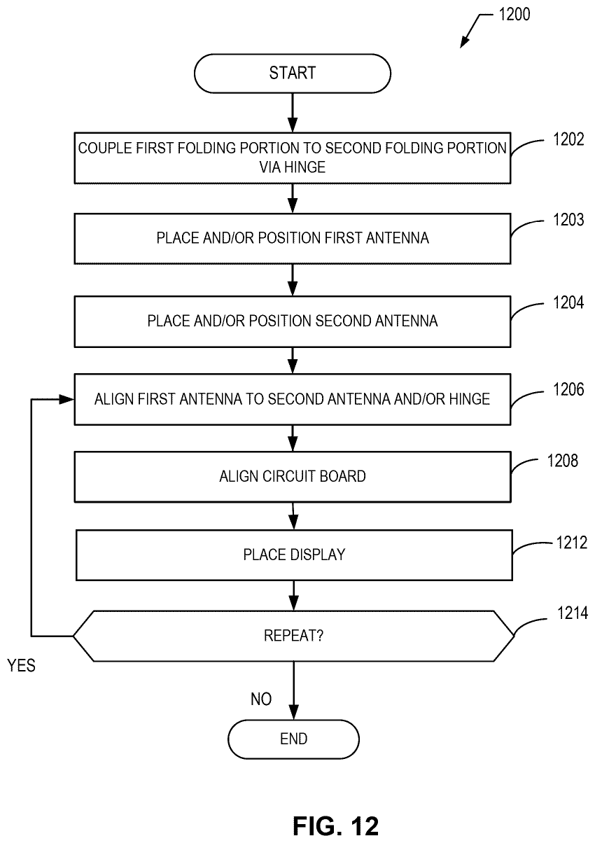

FIG. 12 is a flowchart representative of an example method 1200 to produce examples disclosed herein. In particular, the example method 1200 can be used to produce wireless hinge components, devices and/or assemblies that enable wireless signals to be transmitted across the hinge 106 with a relatively high bandwidth signal across a range of motion (e.g., a full range of motion) of the second folding portion 104 to the first folding portion 102.

At block 1202, the first folding portion 102 is coupled to the second folding portion 104 via the hinge 106, thereby causing the first folding portion 102 to be rotatably coupled to the second folding portion 104.

At block 1203, the first antenna 114 is placed and/or positioned onto the first folding portion 102. In some examples, an additional antenna is placed onto the first folding portion 102. In some such examples, the first antenna 114 is a broadside antenna while the additional antenna is an end-firing antenna.

At block 1204, a second antenna is placed and/or positioned onto the second folding portion 104. In some examples, an additional antenna is placed onto the first second folding portion 104. In some such examples, the second antenna 118 is a broadside antenna while the additional antenna is an end-firing antenna.

At block 1206, in some examples, the first antenna 114 of the first folding portion 102 is aligned to the second antenna 118 of the second folding portion 104 and/or the hinge 106.

At block 1208, in some examples, a circuit board holding at least one of the first antenna 114 or the second antenna 118 is aligned relative to the hinge 106.

At block 1212, in some examples, a display is placed onto the first folding portion 102. In some such examples, circuitry of the second folding portion 104 is to provide a video signal (e.g., a video output) to the first folding portion 102.

At block 1214, it is determined whether to repeat the process. If the process is to be repeated (block 1214), control of the process returns to block 1206. Otherwise, the process ends.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

Example methods, apparatus, systems, and articles of manufacture to enable folding devices with relatively high bandwidth intra-device signals are disclosed herein. Further examples and combinations thereof include the following:

Example 1 includes an apparatus for use with a foldable computing device, the apparatus comprising a hinge by which first and second folding portions of the computing device are rotatably coupled, a first antenna of the first folding portion, a second antenna of the second folding portion, the first and second antennas to be wirelessly communicatively coupled to one another, the first and second antennas separate from the hinge, and equalizer circuitry to enable equalization between the first and second antennas to maintain signals therebetween to meet a BER threshold over a range of motion of the first folding portion relative to the second folding portion.

Example 2 includes the apparatus as defined in example 1, wherein the first and second antennas are wirelessly communicatively coupled via a millimeter wave signal or a sub-terahertz frequency signal.

Example 3 includes the apparatus as defined in any of examples 1 or 2, further including a third antenna of the first folding portion, the third antenna being a broadside antenna, the first antenna being an end-firing antenna.

Example 4 includes the apparatus as defined in example 3, further including a fourth antenna of the second folding portion, the fourth antenna being a broadside antenna, the second antenna being an end-firing antenna.

Example 5 includes the apparatus as defined in any of examples 1 to 4, wherein the first and second antennas are mounted on first and second circuit boards, respectively.

Example 6 includes the apparatus as defined in any of examples 1 to 5, wherein no signal cables extend across the hinge.

Example 7 includes the apparatus as defined in any of examples 1 to 6, wherein the first and second antennas are to transmit and receive video signals for a display.

Example 8 includes the apparatus as defined in any of examples 1 to 7, wherein at least one of the first or second antennas includes a combination antenna having a broadside antenna and an end-firing antenna.

Example 9 includes the apparatus as defined in example 8, wherein the equalization circuitry selects the broadside antenna or the end-firing antenna based on an angle between the first folding portion and the second folding portion.

Example 10 includes the apparatus as defined in any of examples 8 or 9, wherein the equalization circuitry selects a first strength of the broadside antenna and a second strength of the end-firing antenna based on an angle between the first folding portion and the second folding portion.

Example 11 includes the apparatus as defined in any of examples 1 to 10, wherein the equalization circuitry adjusts equalization between the first and second antennas based on an angle between the first folding portion and the second folding portion.

Example 12 includes a foldable computing device comprising a first folding portion to support a display, the first folding portion including a first antenna, a second folding portion to support at least one of an input device or another display, the second folding portion rotatably coupled to the first folding portion at a hinge, the second folding portion including a second antenna, the first and second antennas to be communicatively coupled to one another to enable intra-device signals to be transmitted therebetween, the first antenna and the second antenna separate from the hinge, and equalizer circuitry to perform equalization between the first and second antennas to maintain signals therebetween to meet a BER threshold over a range of motion of the first folding portion relative to the second folding portion.

Example 13 includes the computing device as defined in example 12, wherein the first and second antennas are wirelessly communicatively coupled via a millimeter wave signal or a sub-terahertz frequency signal.

Example 14 includes the computing device as defined in any of examples 12 or 13, wherein the first and second antennas are printed antennas associated with respective radio-frequency integrated circuits (RFICs).

Example 15 includes the computing device as defined in any of examples 12 to 14, wherein the hinge includes a barrel, the first and second antennas external to an outer surface of the barrel.

Example 16 includes the computing device as defined in example 15, wherein no signal cables extend into an inner portion of the barrel.

Example 17 includes the computing device as defined in any of examples 12, wherein the second antenna is to transmit video signals for a display to the first antenna.

Example 18 includes the computing device as defined in example 12, wherein at least one of the first antenna or the second antenna is aimed in a direction generally toward the hinge over an angular range of motion between the first folding portion and the second folding portion.

Example 19 includes the computing device as defined in example 12, wherein the first antenna and the display are powered by a first power source, and the second antenna and the at least one of the input device or the another display are powered by a second power source different from the first power source.

Example 20 includes a method comprising rotatably coupling a first folding portion to a second folding portion via a hinge, placing a first antenna on the first folding portion, placing a second antenna on the second folding portion, the first and second antennas to be wirelessly communicatively coupled to one another, the first and second antennas placed away from the hinge, and electrically coupling equalizer circuitry to at least one of the first antenna or the second antenna, the equalizer circuitry to enable equalization between the first and second antennas so that the first and second antennas can wirelessly communicate over a range of motion of the first folding portion relative to the second folding portion.

Example 21 includes the method as defined in example 20, further including aligning at least one of the first antenna or the second antenna toward the hinge.

Example 22 includes the method as defined in example 20, further including aligning a printed circuit board carrying the first antenna or the second antenna toward the hinge.

Example 23 includes the method as defined in example 20, further including placing a display onto the first folding portion, the display to receive video signals from the second antenna of the second folding portion.

From the foregoing, it will be appreciated that example systems, methods, apparatus, and articles of manufacture have been disclosed that enable folding devices that enable wireless communications with a relatively high data bandwidth across a wide range of rotation about a hinge.

As a result, examples, disclosed herein can enable hinge designs with reduced cabling (e.g., no high speed cabling) passing therethrough. Further, examples disclosed herein can enable more compact and/or smaller hinges of folding computing devices can be enabled. Moreover, examples disclosed herein can enable secure communication across a hinge.

Examples disclosed herein can implement antenna topologies having combination antenna systems that do not necessitate additional power, cost and integration issues. By utilizing mmWave frequencies for wireless hinge signals, reliability issues of known high speed data cabled solutions (e.g., high speed signals routed through the cables can interfere with system integrated radio antennas such as WiFi and cellular) can be reduced (e.g., eliminated). Further, space saved by removing volume related to cable/connector assemblies can enable increased space for extra battery capacity, for example.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1. An apparatus for use with a foldable computing device, the apparatus comprising:
a hinge by which first and second folding portions of the computing device are rotatably coupled;
a first antenna of the first folding portion;
a second antenna of the second folding portion, the first and second antennas to be wirelessly communicatively coupled to one another, the first and second antennas separate from the hinge; and
equalizer circuitry to enable equalization between the first and second antennas to maintain signals therebetween to meet a bit error rate (BER) threshold over a range of motion of the first folding portion relative to the second folding portion.

2. The apparatus as defined in claim 1, wherein the first and second antennas are wirelessly communicatively coupled via a millimeter wave signal or a sub-terahertz frequency signal.

3. The apparatus as defined in claim 1, further including a third antenna of the first folding portion, the third antenna being a broadside antenna, the first antenna being an end-firing antenna.

4. The apparatus as defined in claim 3, further including a fourth antenna of the second folding portion, the fourth antenna being a broadside antenna, the second antenna being an end-firing antenna.

5. The apparatus as defined in claim 1, wherein the first and second antennas are mounted on first and second circuit boards, respectively.

6. The apparatus as defined in claim 1, wherein no signal cables extend across the hinge.

7. The apparatus as defined in claim 1, wherein the first and second antennas are to transmit and receive video signals for a display.

8. The apparatus as defined in claim 1, wherein at least one of the first or second antennas includes a combination antenna having a broadside antenna and an end-firing antenna.

9. The apparatus as defined in claim 8, wherein the equalization circuitry selects the broadside antenna or the end-firing antenna based on an angle between the first folding portion and the second folding portion.

10. The apparatus as defined in claim 8, wherein the equalization circuitry selects a first strength of the broadside antenna and a second strength of the end-firing antenna based on an angle between the first folding portion and the second folding portion.

11. The apparatus as defined in claim 1, wherein the equalization circuitry adjusts equalization between the first and second antennas based on an angle between the first folding portion and the second folding portion.

12. A foldable computing device comprising:
a first folding portion to support a display, the first folding portion including a first antenna;
a second folding portion to support at least one of an input device or another display, the second folding portion rotatably coupled to the first folding portion at a hinge, the second folding portion including a second antenna, the first and second antennas to be communicatively coupled to one another to enable intra-device signals to be transmitted therebetween, the first antenna and the second antenna separate from the hinge; and equalizer circuitry to perform equalization between the first and second antennas to maintain signals therebetween to meet a bit error rate (BER) threshold over a range of motion of the first folding portion relative to the second folding portion.

13. The computing device as defined in claim 12, wherein the first and second antennas are wirelessly communicatively coupled via a millimeter wave signal or a sub-terahertz frequency signal.

14. The computing device as defined in claim 12, wherein the first and second antennas are printed antennas associated with respective radio-frequency integrated circuits (RFICs).

15. The computing device as defined in claim 12, wherein the hinge includes a barrel, the first and second antennas external to an outer surface of the barrel.

16. The computing device as defined in claim 15, wherein no signal cables extend into an inner portion of the barrel.

17. The computing device as defined in claim 12, wherein the second antenna is to transmit video signals for a display to the first antenna.

18. The computing device as defined in claim 12, wherein at least one of the first antenna or the second antenna is aimed in a direction generally toward the hinge over an angular range of motion between the first folding portion and the second folding portion.

19. The computing device as defined in claim 12, wherein:
the first antenna and the display are powered by a first power source, and
the second antenna and the at least one of the input device or the another display are powered by a second power source different from the first power source.

20. A method comprising:
rotatably coupling a first folding portion to a second folding portion via a hinge;
placing a first antenna on the first folding portion;
placing a second antenna on the second folding portion, the first and second antennas to be wirelessly communicatively coupled to one another, the first and second antennas placed away from the hinge; and
electrically coupling equalizer circuitry to at least one of the first antenna or the second antenna, the equalizer circuitry to enable equalization between the first and second antennas so that the first and second antennas can wirelessly communicate over a range of motion of the first folding portion relative to the second folding portion.

21.-23. (canceled)
